(19) United States
(12) Patent Application Publication
(10) Pub. No.: US 2019/0205725 A1
(43) Pub. Date: Jul. 4, 2019

(54) CRACK SENSING TAG AND METHOD

(71) Applicant: Army Armored Academy, Beijing (CN)

(72) Inventors: Haidou Wang, Beijing (CN); Lihong Dong, Beijing (CN); Yawei Xu, Beijing (CN)

(21) Appl. No.: 16/296,250

(22) Filed: Mar. 8, 2019

(30) Foreign Application Priority Data
Jul. 26, 2018 (CN) 2018108377451

(51) Int. Cl. G06K 19/077; G08B 13/24; H04B 17/10; H04B 17/13

(52) U.S. Cl. CPC G06K 19/07798; G08B 13/2417; G08B 13/2434; H04B 17/13; G06K 19/0772; H04B 17/104; G08B 13/2468

(57) ABSTRACT

Embodiments of the present disclosure provide a crack sensing tag including a dielectric substrate, a tag chip, an antenna and a metal patch. The tag chip and the antenna are respectively attached to an upper surface of the dielectric substrate, the tag chip is connected with the antenna, the metal patch is attached to a lower surface of the dielectric substrate, and the antenna is connected with the metal patch. The crack sensing tag may be removed without breaking its geometry after a monitoring cycle for the next surface crack monitoring, as the occurrence of cracks is monitored. The monitoring region is a coverage region of the crack sensing tag, which is complementary to a coupling tag, enabling the further enlarging of the crack sensing region to monitor the metal member to be tested in all dimensions. The crack sensing tag identifies crack depth variations up to millimeter accuracy.

### TECHNICAL FIELD

The presently disclosed subject matter generally relates to the field of metal surface crack sensing and radio frequency identification. Particularly, the present subject matter relates to a crack sensing tag and a crack sensing method.

### BACKGROUND

Surface cracks are common defects in the use of metal members. They are widely found in metal members such as, oil and gas pipelines, bridges, and aircraft skins, and are prone to cause serious safety hazards. Therefore, it is often necessary to monitor the crack generation and expansion of metal members by means of sensors during service in real time.

Traditional crack devices include fiber optic sensors, piezoelectric ceramic sensing coatings, and antenna sensors. These traditional crack monitoring methods require the connection of measuring device and sensors by wires. However, the wired monitoring method not only brings hidden dangers to the wiring, but also limits the layout of the sensing apparatus.

At present, the radio frequency identification system can obtain information pre-stored in the sensing apparatus through wireless and passive information transmission. This wireless and passive information transmission method has received a lot of attention. In the past ten years, many types of sensing tags have been born, which have realized various monitoring functions such as monitoring for temperature, humidity, corrosion degree and displacement, and become one of the important technologies for building Internet of Things and multi-sensor networks.

However, the existing crack sensing tags are mostly vulnerable, that is, the geometry of the sensing apparatus changes with the crack propagation process, resulting in a decrease in the performance of the sensing apparatus. For example, the threshold of the transmission power of the signal-transmitting device of the sensing apparatus is increased, the limit reading distance of the sensing apparatus is lowered, and the resonant frequency is shifted, so that the sensing apparatus cannot read the data normally. Although it is currently possible to perform wireless and passive metal surface crack monitoring by monitoring changes in the performance of the sensing apparatus, the structure of such crack sensing tags are destroyed as the crack changes, so they can only be used once and cannot be reused.

At the same time, another existing crack sensing tag utilizes a pair of coupling tags as sensing apparatuses for crack monitoring. When a crack occurs in the interval between two mutually coupled tags, the relative distance between the coupled tags increases as the crack propagates, so that the coupling state of the coupled tags and the performance parameters of the two coupling apparatuses are changed. Therefore, the crack propagation can be characterized by the change in the performance parameters of the coupled tags. These coupled tags do not require damage to the geometry of the sensing apparatus for crack monitoring, but only cracks in the intervals between the two-coupled tags can be monitored. For cracks that appear in the region covered by the coupled tags, there is currently no crack monitoring method that does not require damage to the tag structure.

Therefore, there is currently no crack sensing tag that can be reused and can wirelessly monitor cracks in the region covered by crack sensing tags, and complements the method of coupled tags as crack sensing tags to monitor crack generation and propagation in all dimensions.

In light of above discussion, there exists need for improved crack sensing tags and methods.

### SUMMARY

In order to solve the problem of the current lack of a crack sensing tag that is reusable and capable of wirelessly monitoring cracks in the region covered by crack sensing tags and complements the method in which a coupling tag is used as crack sensing tag, the present disclosure provides a crack sensing tag including a dielectric substrate, a tag chip, an antenna and a metal patch. The tag chip and the antenna being respectively attached to an upper surface of the dielectric substrate. Further, the tag chip and the antenna being connected. Furthermore, the metal patch being attached to a lower surface of the dielectric substrate. Further, the antenna and the metal patch being connected to each other.

An embodiment of the present disclosure provides a dielectric substrate, a tag chip, an antenna, and a metal patch. The tag chip and the antenna being respectively attached to an upper surface of the dielectric substrate. The tag chip being connected to the antenna. The metal patch being attached to a lower surface of the dielectric substrate, and the antenna being connected to the metal patch.

According to an aspect of the present disclosure, the dielectric substrate and the metal patch are respectively attached to a surface of a metal member to be tested, the metal member to be tested being a flat metal member. A crack generated on the surface of the metal member to be tested being perpendicular to a long side of the crack sensing tag.

According to another aspect of the present disclosure, the crack sensing tag also includes a shorting pin through which the antenna is connected with the metal patch.

According to another embodiment of the present disclosure, the tag chip is spaced apart from the antenna, and opposite pins of the tag chip are respectively connected to the antenna.

According to another embodiment of the present disclosure, a geometry parameter of the antenna is determined using an electromagnetic simulation software including at least one of a high frequency structural simulator (HFSS) or computer simulation technology (CST).

Another embodiment of the present disclosure provides a crack sensing method. The method includes determining a simulation frequency range of a crack sensing tag according to an operating frequency range of a tag chip of the crack sensing tag. The method further includes determining a structural parameter of an antenna of the crack sensing tag such that a resonant frequency of the crack sensing tag does not exceed the simulation frequency range. The method furthermore includes determining an actual operating frequency range of the crack sensing tag and monitoring the crack according to a power transmission coefficient curve. The actual operating frequency range does not exceed the simulation frequency range.

According to an aspect of the present disclosure, the resonant frequency includes a first resonant frequency and a second resonant frequency. The first resonant frequency being a resonant frequency of the crack sensing tag when a crack depth is zero. The second resonant frequency being a resonant frequency of the crack sensing tag when the crack depth is an upper limit of the crack.

According to another aspect of the present disclosure, the determining of the structural parameter of the antenna of the crack sensing tag (herein after may also be referred as a sensing device without change in its meaning) further includes adjusting the structural parameter of the antenna of the crack sensing tag by obtaining a frequency of the metal member to be tested corresponding to an intersection of an impedance curve of the antenna and an impedance curve of the tag chip under different crack depth conditions according to an impedance variation curve. When the crack depth is zero, the frequency corresponding to the intersection of the impedance curve of the antenna and the impedance curve of the tag chip is the first resonant frequency. When the crack depth is the upper limit of the crack, the frequency corresponding to the intersection of the impedance of the antenna and the impedance of the tag chip is the second resonant frequency. The impedance variation curve is used to indicate a relationship between an impedance of the antenna, an impedance of the tag chip, and an actual operating frequency of the crack sensing tag.

According to another aspect of the present disclosure, the power transmission coefficient variation curve is used to indicate a relationship between a power transmission coefficient of the crack sensing tag, an impedance of the tag chip, and an impedance of the antenna.

According to another aspect of the present disclosure, the power transmission coefficient of the power transmission coefficient variation curve is calculated as:

$$τ = \frac{4 Re ( {Z}_{tag} ) Re ( {Z}_{chip} )}{\vert {Z}_{tag} + {Z}_{chip} \vert}$$

wherein τ is the power transmission coefficient of the crack sensing tag, z_{tag} is the impedance of the tag antenna, z_{chip} is the impedance of the tag chip; Rc (Z_{tag}) and Re(Z_{chip}) are the real parts of the impedance of the antenna and the tag chip, respectively.

According to another aspect of the present disclosure, the determining the actual operating frequency range of the crack sensing tag includes: for the depth of the crack within the upper limit value, a frequency corresponding to the peak of the power transmission coefficient of the crack sensing tag is a maximum value of the actual operating frequency; any frequency greater than the lower limit of the simulation frequency range and smaller than the maximum value of the actual operating frequency may be used as a minimum value of the actual operating frequency.

Another embodiment of the present disclosure provides a crack sensing tag, wherein by connecting the tag chip to the antenna on the upper surface of the dielectric substrate of the crack sensing tag, then connecting the antenna to the metal patch on the lower surface of the dielectric substrate through the shorting pin, and the metal patch is attached to the metal member to be tested, a current generated in the crack sensing tag is introduced to the surface of the metal member to be tested. In another aspect, the present disclosure further provides a crack sensing method, which configures a simulation frequency range of a crack sensing tag according to an operating frequency range of a tag chip of the crack sensing tag, determines a structural parameter of the antenna by using a resonant frequency of the crack sensing tag at different crack depths not exceeding the simulation frequency range as a reference, and then determines an actual operating frequency range of the crack sensing tag according to a power transmission curve and monitors the crack.

According to another aspect of the present disclosure, the crack sensing tag is required to be placed on the surface of the metal member to be tested during monitoring, has a higher recognition accuracy for the crack of the surface of the metal member to be tested perpendicular to the long side of the crack sensing tag, and may be removed after the end of a monitoring period for the next surface crack monitoring without breaking the geometry of the crack sensing tag. The monitoring region is a coverage region of the crack sensing tag, which is complementary to a coupling tag, which may further enlarge the crack sensing region, and comprehensively monitor whether the metal member to be tested is cracked and the depth of the crack.

According to another aspect of the present disclosure, the determining the actual opening frequency range of the crack sensing tag further includes for the depth of the crack being within the upper limit value a frequency corresponding to the peak of the power transmission coefficient of the crack sensing tag is a maximum value of the actual operating frequency.

According to yet another aspect of the present disclosure, the determining the actual opening frequency range of the crack sensing tag further includes for any frequency greater than the lower limit of the simulation frequency range and smaller than the maximum value of the actual operating frequency may be used as a minimum value of the actual operating frequency.

Yet another embodiment of the present disclosure provides a crack sensing method. The method includes determining, by a tag chip of a crack sensing tag, a simulation frequency range of the crack sensing tag according to an operating frequency range of a tag chip of the crack sensing tag. The method further includes determining, by the tag chip, a structural parameter of an antenna of the crack sensing tag by adjusting the structural parameter such that a resonant frequency of the crack sensing tag does not exceed the simulation frequency range, wherein the resonant frequency comprises a first resonant frequency and a second resonant frequency, the first resonant frequency being a resonant frequency of the crack sensing tag when a crack depth is zero, further wherein the second resonant frequency being a resonant frequency of the crack sensing tag when the crack depth is an upper limit of the crack. The method also includes determining, by the tag chip, an actual operating frequency range of the crack sensing tag. The method further includes monitoring, by the tag chip, the crack according to a power transmission coefficient curve, wherein the actual operating frequency range does not exceed the simulation frequency range.

According to an aspect of the present disclosure, the crack sensing tag comprises a dielectric substrate, a tag chip, an antenna, and a metal patch, the tag chip and the antenna being respectively attached to an upper surface of the dielectric substrate, wherein the tag chip being connected to the antenna, wherein the metal patch being attached to a lower surface of the dielectric substrate, and the antenna being connected to the metal patch.

According to another aspect of the present disclosure, the adjusting the structural parameter of the antenna of the crack sensing tag further includes: obtaining a frequency of the metal member to be tested corresponding to an intersection of an impedance curve of the antenna and an impedance curve of the tag chip under different crack depth conditions according to an impedance variation curve. When the crack depth is zero, the frequency corresponding to the intersection of the impedance curve of the antenna and the impedance curve of the tag chip is the first resonant frequency. Alternatively, when the crack depth is the upper limit of the crack, the frequency corresponding to the intersection of the impedance of the antenna and the impedance of the tag chip is the second resonant frequency. Further, the impedance variation curve is used to indicate a relationship between an impedance of the antenna, an impedance of the tag chip, and an actual operating frequency of the crack sensing tag.

According to another aspect of the present disclosure, the determining the actual opening frequency range of the crack sensing tag further includes for the depth of the crack being within the upper limit value a frequency corresponding to the peak of the power transmission coefficient of the crack sensing tag is a maximum value of the actual operating frequency, and for any frequency greater than the lower limit of the simulation frequency range and smaller than the maximum value of the actual operating frequency may be used as a minimum value of the actual operating frequency.

According to another aspect of the present disclosure, the crack sensing method further includes determining a geometry parameter of the antenna by using an electromagnetic simulation software comprising at least one of a high frequency structural simulator (HFSS) or computer simulation technology (CST).

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1 illustrates a structural view of an exemplary crack sensing tag, in accordance with an embodiment of the present disclosure;

FIG. 2 illustrates a flow diagram of a crack sensing method, in accordance with an embodiment of the present disclosure;

FIG. 3A illustrates a curve showing variation in real parts of impedance of a crack sensing method, in accordance with an embodiment of the present disclosure;

FIG. 3B illustrates a curve showing variation in unreal parts of impedance of a crack sensing method, in accordance with an embodiment of the present disclosure;

FIG. 4 illustrates a curve showing variation in power transmission coefficient of a crack sensing method, in accordance with an embodiment of the present disclosure;

FIG. 5A illustrates a curve showing variation in a threshold emission power of a crack sensing method, in accordance with an embodiment of the present disclosure;

FIG. 5B illustrates a curve showing variation in an ultimate reading distance of a crack sensing method, in accordance with an embodiment of the present disclosure; and

FIG. 6 illustrates a curve showing relationships among a crack depth, a threshold emission power, and an ultimate reading distance of a crack sensing method, in accordance with an embodiment of the present disclosure.

### DETAILED DESCRIPTION

The following detailed description is made with reference to the figures. Exemplary embodiments are described to illustrate the disclosure, not to limit its scope, which is defined by the claims. Those of ordinarily skilled in the art will recognize a number of equivalent variations in the description that follows.

Reference throughout this specification to “a select embodiment,” “one embodiment,” or “an embodiment” means that a particular feature, structure, or characteristic described in connection with the embodiment is included in atleast one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subj ect matter.

Most of the current crack sensing tags use fragile tags. The geometry of the fragile tag changes with the crack propagation process, resulting in reduced tag performance or even normal readability. Although passive, wireless metal surface monitoring may be achieved through attenuation of the fragile tag performance, this crack sensing tag may only be used once, and the structure has been destroyed after the crack is detected and may not be used repeatedly. Further, the replacement thereof is frequent, the cost is high, and a large amount of resources may be wasted.

Another crack monitoring method is to use a coupling tag for crack monitoring. When using a pair of coupled tags to monitor cracks, if a crack occurs in the interval between two mutually coupled tags, the relative distance between the coupled tags increases as the crack propagates, so that the coupling state and the performance parameters of the two tags are changed. Therefore, the crack propagation may be characterized by the change in the performance parameters of the tags. Although this type of coupled tag may achieve crack monitoring without breaking the geometry of the crack sensing tag, only cracks in the interval between two coupled tag may be monitored, and cracks appearing in the region covered by the tags may not be monitored.

The present disclosure provides a crack sensing tag including a dielectric substrate, a tag chip, an antenna and a metal patch, the tag chip and the antenna being respectively attached to an upper surface of the dielectric substrate, the tag chip and the antenna being connected, the metal patch being attached to a lower surface of the dielectric substrate, and the antenna and the metal patch being connected.

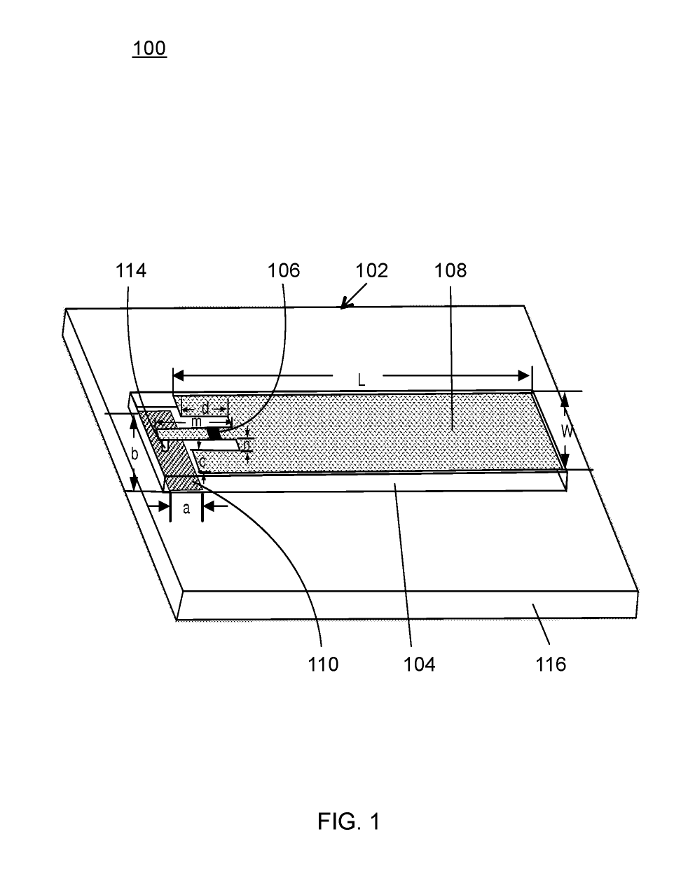

FIG. 1 illustrates a structural view 100 of an exemplary crack sensing tag 102, in accordance with an embodiment of the present disclosure. As shown, the crack sensing tag 102 includes a dielectric substrate 104, a tag chip 106, an antenna 108, and a metal patch 110. The tag chip 106 and the antenna 108 being respectively attached to an upper surface of the dielectric substrate 104. The tag chip 106 being connected to the antenna 108. Further, the metal patch 110 being attached to a lower surface of the dielectric substrate 104. The antenna 108 being connected to the metal patch 110.

In some embodiments, after the crack sensing tag 102 binds the tag chip 106 on the upper surface of the dielectric substrate 104 to the antenna 108, the antenna 108 is connected to the metal patch 110 on the lower surface of the dielectric substrate 104, so that the current generated by the crack sensing tag 102 is introduced to the surface of a metal member to be tested 112 for judging the occurrence and expansion of cracks on the metal member to be tested 112 by measuring the path change of the current in the crack sensing tag 102, including whether the crack is generated and the depth of the crack.

In some embodiments, the crack sensing tag 102 may be removed after the end of a monitoring period for the next surface crack monitoring without breaking the geometry of the crack sensing tag 102. The monitoring region may be a coverage region of the crack sensing tag 102, which is complementary to a coupling tag, which may further enlarge the crack sensing region, and comprehensively monitor the metal member to be tested 112.

Based on above embodiment, the dielectric substrate 104 and the metal patch 110 are respectively attached to a surface of the metal member to be tested 112. The metal member to be tested 112 may be a flat metal member. A crack generated on the surface of the metal member to be tested 112 may be perpendicular to a long side of the crack sensing tag 102.

Further, the crack sensing tag 102 includes a shorting pin 114 through which the antenna 108 is connected with the metal patch 110.

In some embodiments, the tag chip 106 is spaced apart from the antenna 108. Further, opposite pins of the tag chip 106 are respectively connected to the antenna 108, so that the tag chip 106 is connected with the antenna 108.

In some embodiments, the tag chip 106 is configured to determine a simulation frequency range of the crack sensing tag according to an operating frequency range of a tag chip of the crack sensing tag. Further, the tag chip 106 may be configured to determine a structural parameter of an antenna of the crack sensing tag such that a resonant frequency of the crack sensing tag does not exceed the simulation frequency range. Further, the tag chip 106 may be configured to determine an actual operating frequency range of the crack sensing tag and monitor the crack according to a power transmission coefficient curve, wherein the actual operating frequency range does not exceed the simulation frequency range.

In some embodiments, the tag chip 106 is configured to determine a geometry parameter of the antenna by using any existing or later developed electromagnetic simulation software. Examples of the electromagnetic simulation software may include, but are not limited to, a high frequency structural simulator (HFSS) and a computer simulation technology (CST). In some embodiments, the geometry parameter of the antenna 108 is determined using an electromagnetic simulation software. Examples of the electromagnetic simulation software may include, but not limited to, a high frequency structural simulator (HFSS) or computer simulation technology (CST).

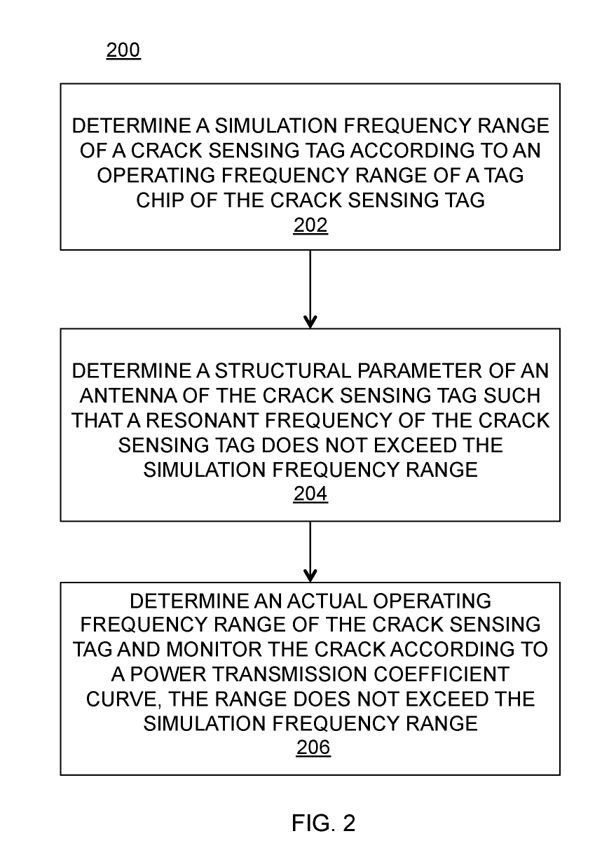

FIG. 2 illustrates a flow diagram 200 of a crack sensing method, in accordance with an embodiment of the present disclosure. The crack sensing tag may be the crack sensing tag 102 as discussed with reference to FIG. 1. The crack sensing tag includes dielectric substrate, a tag chip, an antenna and a metal patch. The tag chip and the antenna being respectively attached to an upper surface of the dielectric substrate. Further, the tag chip and the antenna are being connected to each other. The metal patch being attached to a lower surface of the dielectric substrate, and the antenna and the metal patch are connected.

At step 202, a simulation frequency range of a crack sensing tag is determined according to an operating frequency range of a tag chip of the crack sensing tag. In some embodiments, the tag chip of the crack sensing tag is configured to determine the simulation frequency range of the crack sensing tag according to the operating frequency range of the tag chip of the crack sensing tag.

Then at step 204, a structural parameter of an antenna of the crack sensing tag is determined such that a resonant frequency of the crack sensing tag does not exceed the simulation frequency range. In some embodiments, the tag chip of the crack sensing tag is configured to determine the structural parameter of an antenna of the crack sensing tag such that a resonant frequency of the crack sensing tag does not exceed the simulation frequency range.

Thereafter, at step 206, an actual operating frequency range of the crack sensing tag is determined. Further, the crack is monitored according to a power transmission coefficient curve. The range does not exceed the simulation frequency range. In some embodiments, the tag chip of the crack sensing tag is configured to determine an actual operating frequency range of the crack sensing tag and monitor the crack according to the power transmission coefficient curve such that the range does not exceed the simulation frequency range.

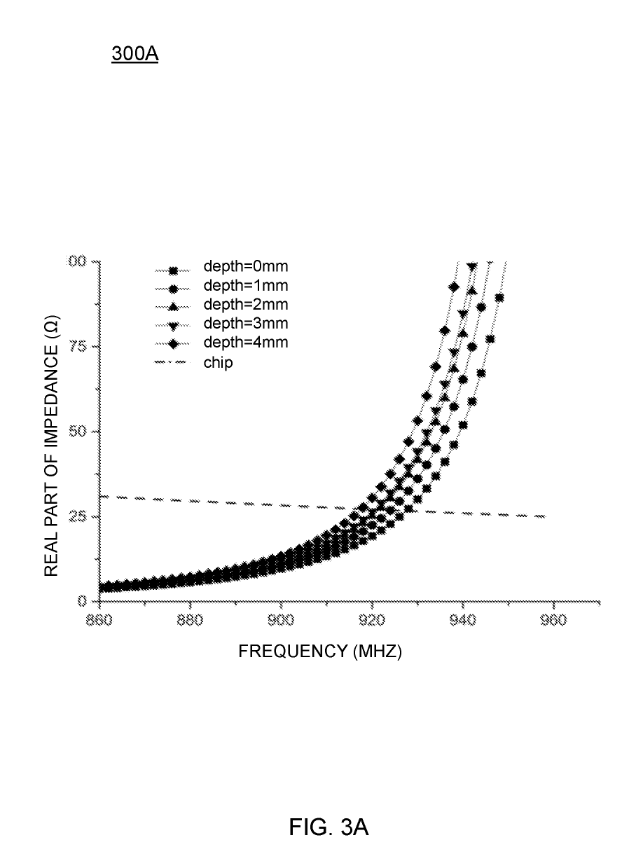

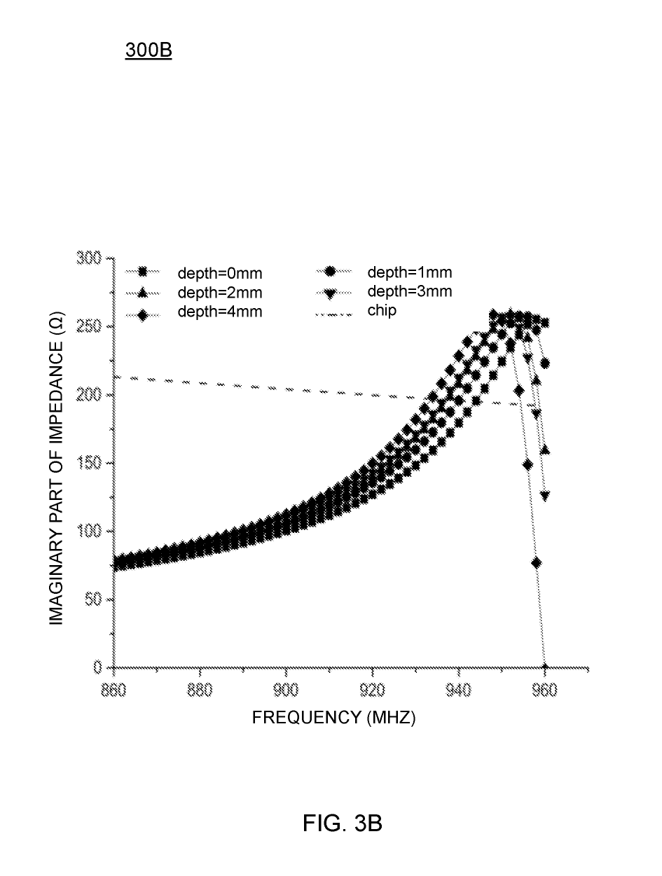

Turning now to FIG. 3A and FIG. 3B illustrates curves 300A-300B showing variation in impedance of a crack sensing method, in accordance with various embodiments of the present disclosure. The crack sensing method is implemented by using a crack sensing tag (also referred as a sensing device) such as the crack sensing tag 102 as discussed with reference to the FIG. 1. The crack sensing tag 102 includes a dielectric substrate 104, a tag chip 106, an antenna 108, and a metal patch 110. The tag chip 106 and the antenna 108 being respectively attached to an upper surface of the dielectric substrate 104. The tag chip 106 being connected to the antenna 108. Further, the metal patch 110 being attached to a lower surface of the dielectric substrate 104. The antenna 108 being connected to the metal patch 110.

The curve 300A in the FIG. 3A shows relationships among the real part of the impedance of an antenna input, the real part of the impedance of the tag chip and the frequency of a crack sensing tag 102 under different crack depth conditions. The curve 300B in the FIG. 3B shows relationships among the imaginary part of the impedance of the antenna input and the imaginary part of the impedance of the tag chip and the frequency of the crack sensing tag 102 under different crack depth conditions. The structural parameter of the antenna of the crack sensing tag 102 may be adjusted by obtaining a frequency of the metal member to be tested corresponding to an intersection of an impedance curve of the antenna and an impedance curve of the tag chip under different crack depth conditions according to an impedance variation curve. In some embodiments, if the crack depth is zero, then the frequency corresponding to the intersection of the impedance curve of the antenna and the impedance curve of the tag chip is the first resonant frequency. Alternatively, if the crack depth is the upper limit of the crack, then the frequency corresponding to the intersection of the impedance of the antenna and the impedance of the tag chip is the second resonant frequency.

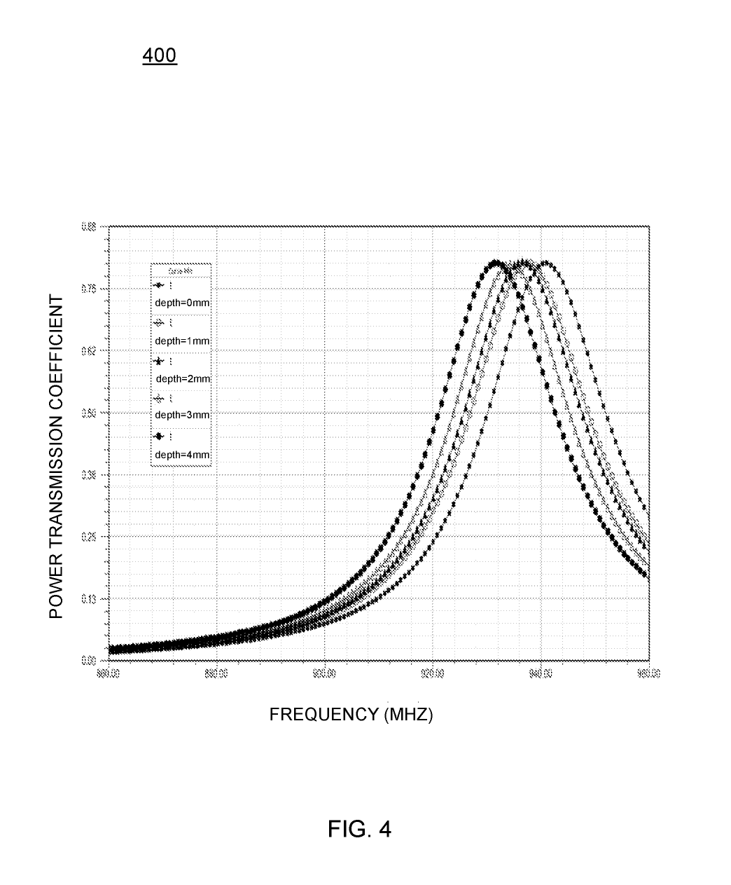

FIG. 4 illustrates a curve 400 showing variation in power transmission coefficient of a crack sensing method, in accordance with an embodiment of the present disclosure. As shown in the curve 400 of the FIG. 4, the power transmission coefficient variation curve i.e. the curve 400 is used to indicate a relationship between a power transmission coefficient of the crack sensing tag 102, an impedance of the tag chip, and an impedance of the antenna.

The power transmission coefficient of the power transmission coefficient variation curve may be calculated as follows:

$$τ = \frac{4 Re ( {Z}_{tag} ) Re ( {Z}_{chip} )}{\vert {Z}_{tag} + {Z}_{chip} \vert}$$

wherein τ is the power transmission coefficient of the crack sensing tag, Z_{tag} is the) impedance of the antenna, Z_{chip} is the impedance of the tag chip; and Re (Z_{tag}) and Re (Z_{chip}) are the real parts of the impedance of the antenna and the tag chip, respectively.

In some embodiments, the power transmission coefficient is calculated according to the impedance of the antenna and the tag chip, and a variation curve for the power transmission coefficient is drawn to determine the operating frequency range when the crack sensing tag 102 monitors in real time.

In some embodiments, while determining the actual operating frequency range of the crack sensing tag 102 further includes, determining if the depth of the crack is within the upper limit value, then a frequency corresponding to the peak of the power transmission coefficient of the crack sensing tag 102 is a maximum value of the actual operating frequency. In some embodiments, any frequency greater than the lower limit of the simulation frequency range and smaller than the maximum value of the actual operating frequency may be used as a minimum value of the actual operating frequency. In some embodiments, according to the variation curve (i.e. the curve 400) for power transmission coefficient, the frequency corresponding to the peak value of the power transmission coefficient when the crack depth is at the upper limit is determined as the maximum value of the actual operating frequency of the crack sensing tag 102. The minimum value of the actual operating frequency of the crack sensing tag 102 is required to be greater than the minimum value of the simulation frequency range and less than the maximum value of the actual operating frequency.

In some embodiments, a tag reader or a tag writer may be used to read the performance parameters of the crack sensing tag 102. In an non-limiting exemplary scenario, the tag reader/tag writer includes a Tagformance reader/writer.

In some embodiments, the metal member to be tested is used as a ground plate, which forms a microstrip antenna structure together with the crack sensing tag 102. Further, generation of the surface crack of the metal member to be tested prolongs the path of the surface current, that is, the electrical length of the microstrip antenna is increased, and the resonant frequency of the crack sensing tag 102 is lowered. As the crack deepens, the electrical length increases, the resonant frequency decreases, and the tag performance varies, i.e., variation in parameters including a threshold emission power and an ultimate reading distance.

The crack sensing tag 102 is used to monitor the surface crack of the metal member to be tested. The crack sensing tag 102 monitors the surface crack by attaching a crack sensing tag on the surface of a metal member to be tested. The crack sensing tag 102 configures the sweep range of a tag reader to an actual operating frequency range of the crack sensing tag and emitting electromagnetic waves to the crack sensing tag 102 to obtain a threshold emission power and an ultimate reading distance at which the crack sensing tag 102 may be activated. The crack sensing tag 102 observes variation of the threshold emission power and the ultimate reading distance of the crack sensing tag 102. In some embodiments, if the threshold emission power gradually decreases from an initial stable value or the ultimate reading distance increases from a stable value, then the metal member is cracked and the crack depth gradually increases.

The following non-limiting exemplary scenario explains the crack sensing method in detail. As discussed with reference to the FIG. 1, the metal member to be tested is an aluminum plate having a volume of 100×100×5 mm³. Among them, the tag chip selects Alien Higgs-3, and its input impedance at 915 MHz is Zchip=(27+j201) Ω. The volume of the dielectric substrate is 88×30×3 mm³, and the material is selected to be Fr4 with a relative dielectric constant of 4.4 and a loss tangent of 0.02. The shorting pin is a cylindrical structure made of copper with a diameter of 1 mm and a length of 3 mm. Both the antenna and the rectangular metal patch are made by copper foil etching and have a thickness of 10 μm.

As shown in the FIGS. 3A and 3B, a curve for input impedance of the crack sensing tag 102 under different crack depth conditions is obtained by simulation. Before the simulation, a U-shaped crack with a length of 100 mm and a width of 0.5 mm is drawn in the center of the aluminum plate to be tested. This surface crack is perpendicular to the long side of the sensing tag. The size of the air box required for the simulation is configured to 300×300×300 mm³ with a center frequency of 915 MHz. Since the selected Alien Higgs-3 chip operates at 860-960 MHz, the simulation frequency of the tag chip is configured to 860-960 MHz. A curve for impedance of the antenna of the crack sensing tag 102 is simulated in different crack depths (0 mm, 1 mm, 2 mm, 3 mm, 4 mm) in this frequency range. Through the optimization for geometric parameters of the tag antenna, the frequency corresponding to the intersection of the impedance value of the tag antenna and the impedance value of the chip is guaranteed to be within 860-960 MHz. In the present example, the optimized geometric parameter for the tag antenna is: a=7 mm, b=28 mm, c=8 mm, d=10 mm, m=17 mm, n=4 mm, L=78 mm, W=28 mm. As the crack depth increases, the real and imaginary parts of the antenna impedance appear to increase.

Turning now to the FIG. 4, the curve 400 for power transmission factor calculated using impedance data for determining the actual operating frequency range of the crack sensing tag. The relationship between the power transmission factor and the input impedance is as follows:

$$τ = \frac{4 Re ( {Z}_{tag} ) Re ( {Z}_{chip} )}{\vert {Z}_{tag} + {Z}_{chip} \vert}$$

wherein Z_{tag} represents the antenna impedance of the crack sensing tag, and Z_{chip} represents the chip impedance of the tag. Re (Z_{tag}) And, Re (Z_{chip}) are the real parts of the impedance of the antenna and the tag chip of the crack sensing tag 102, respectively. The closer the power transmission factor is to 1, the better the impedance matching between the antenna and the chip. The frequency corresponding to the maximum value of the power transmission factor is the resonant frequency. It is known from the FIG. 4 that as the crack depth increases, the resonant frequency of the crack sensing tag 102 shifts to the left. The greater the crack depth in the 900-930 MHz range, the higher the power transmission factor of the tag, indicating that the expansion of the surface crack depth may improve the performance of the crack sensing tag 102. Therefore, 900-930 MHz is selected as the frequency range at which the crack sensing tag 102 of the present disclosure actually monitors.

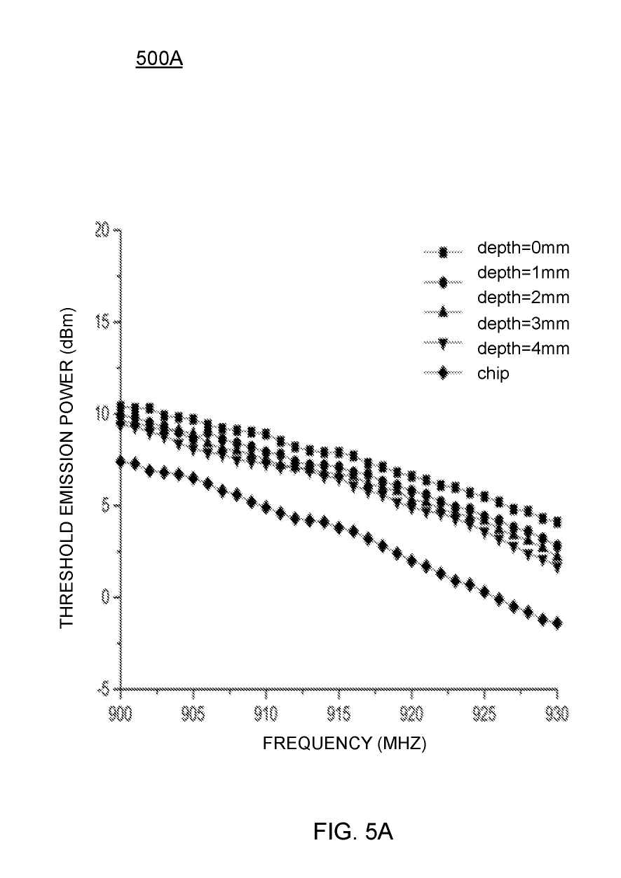

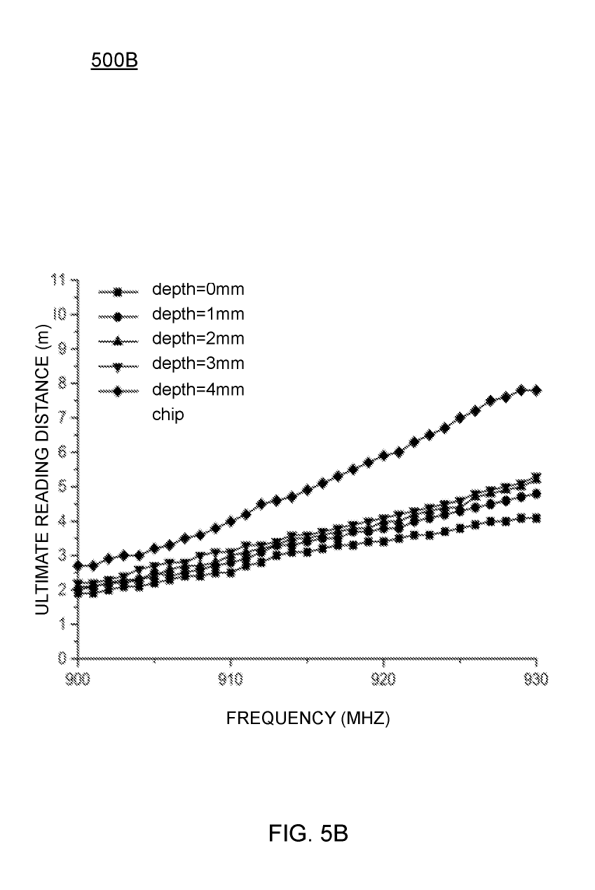

FIG. 5A illustrates a curve 500A showing variation in a threshold emission power of a crack sensing method, in accordance with an embodiment of the present disclosure. FIG. 5B illustrates a curve 500B showing variation in an ultimate reading distance of a crack sensing method, in accordance with an embodiment of the present disclosure; and

As shown in the FIGS. 5A-5B, a tag reader/writer such as a Tagformance reader has a sweep range from 900 MHz to 930 MHz in 1 MHz steps. During the test, the crack sensing tag 102 is placed in the center of the aluminum plate so that the crack length direction is perpendicular to the long side of the tag. In an example, the distance between the crack sensing tag 102 and the Tagformance is kept at 30 cm. The relationship between the threshold emission power and reading distance of the tag reader/writer and the power transmission factor is as follows:

$${P}_{th} = \frac{{P}_{sense}}{{G}_{reader} {{G}_{tag} ( \frac{λ}{4 π r} )}^{2} τ}$$

$${R}_{max} = \frac{λ}{4 π } \sqrt{\frac{τ {G}_{tag} EIRP}{{P}_{sense}}}$$

wherein Pₜₕ is the threshold power that the reader/writer may emit to activate the tag, Pₛₑₙₛₑ is the minimum activation power required by the chip, G_{reader} and G_{tag} represent the directional gain of the reader/writer and the crack sensing tag 102, respectively, λ is the wavelength of the reader/writer signal, and d is the distance between the reader/writer and the tag. Rₘₐₓ indicates the ultimate reading distance of the forward link, and EIRP is the effective isotropic radiated power. According to the simulation results as depicted in the curve 500A and the curve 500B, it can be inferred: within 900-930 MHz, as the crack depth increases, the threshold emission power Pₜₕ decreases and the ultimate reading distance Rₘₐₓ increases. The actual test results of the FIGS. 5A-5B are consistent with the simulation inference. Therefore, the Tagformance reader may be used to collect two parameters of the threshold emission power and the ultimate reading distance of the crack sensing tag 102 passively and wirelessly to characterize the surface crack expansion of the metal member.

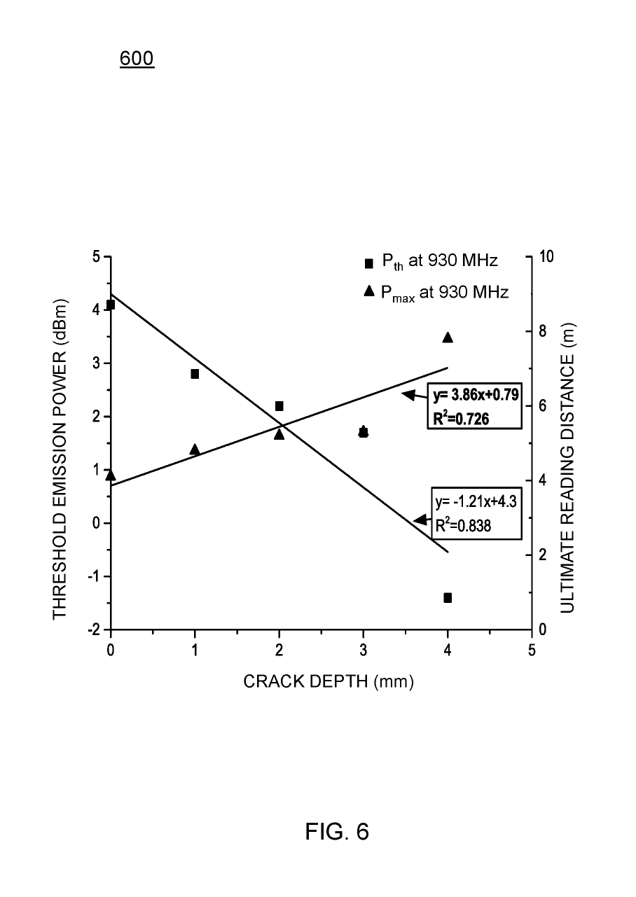

FIG. 6 illustrates a curve 600 showing relationships among a crack depth, a threshold emission power, and an ultimate reading distance of a crack sensing method, in accordance with an embodiment of the present disclosure. As shown in FIG. 6, the curve 600 is a graph showing the relationship among the crack depth, the actual tested threshold emission power and the ultimate reading distance when a crack sensing tag (such as the crack sensing tag 102 of the FIG. 1) has a maximum operating frequency of 930 MHz.

It can be seen from the curve 600 that the surface crack depth, the threshold emission power and the ultimate reading distance all exhibit a linear relationship. Among them, the crack depth is inversely proportional to the threshold emission power, and the surface crack depth is proportional to the ultimate reading distance. According to the established linear relationship, the variation in the threshold emission power or the limit reading distance may be used in the crack monitoring process to determine the crack depth.

Within the actual operating frequency range, as the crack depth increases, the threshold emission power decreases, and the ultimate reading distance increases, that is, the crack depth is inversely proportional to the threshold emission power, and the crack depth is proportional to the ultimate reading distance. According to the established linear relationship among the crack depth, the threshold emission power and the reading distance, the variation in the threshold emission power or the limit reading distance may be used in the crack monitoring process to determine the crack depth. It should be noted that in the example of the present disclosure, the monitoring accuracy of the crack depth is on the order of millimeters.

The crack sensing tag provided by the present disclosure is required to be placed on the surface of the metal member to be tested during monitoring, has a higher recognition accuracy for the crack of the surface of the metal member to be tested perpendicular to the long side of the crack sensing tag, and may be removed after the end of a monitoring period for the next surface crack monitoring without breaking the geometry of the crack sensing tag. The monitoring region may be a coverage region of the crack sensing tag, which is complementary to a coupling tag, which may further enlarge the crack sensing region, and comprehensively monitor whether the metal member to be tested is cracked and the depth of the crack. The crack sensing tag may identify variations in crack depth up to millimeter accuracy.

The present disclosure further provides a crack sensing method including determining a simulation frequency range of a crack sensing tag according to an operating frequency range of a tag chip. The method further includes determining a structural parameter of an antenna of the crack sensing tag such that a resonant frequency of the crack sensing tag does not exceed the simulation frequency range. The method furthermore includes determining an actual operating frequency range of the crack sensing tag. The method also includes monitoring the crack according to a power transmission coefficient curve. The actual operating frequency range does not exceed the simulation frequency range.

In some embodiments, the resonant frequency includes a first resonant frequency and a second resonant frequency. The first resonant frequency being a resonant frequency of the crack sensing tag when a crack depth is zero. Further, the second resonant frequency being a resonant frequency of the crack sensing tag when the crack depth is an upper limit of the crack.

An embodiment of the present disclosure provides a crack sensing method. The crack sensing method includes determining, by a tag chip of a crack sensing tag, a simulation frequency range of the crack sensing tag according to an operating frequency range of a tag chip of the crack sensing tag. The method further includes determining, by the tag chip, a structural parameter of an antenna of the crack sensing tag by adjusting the structural parameter such that a resonant frequency of the crack sensing tag does not exceed the simulation frequency range, wherein the resonant frequency comprises a first resonant frequency and a second resonant frequency, the first resonant frequency being a resonant frequency of the crack sensing tag when a crack depth is zero, further wherein the second resonant frequency being a resonant frequency of the crack sensing tag when the crack depth is an upper limit of the crack. The method also includes determining, by the tag chip, an actual operating frequency range of the crack sensing tag. The method further includes monitoring, by the tag chip, the crack according to a power transmission coefficient curve, wherein the actual operating frequency range does not exceed the simulation frequency range.

According to an aspect of the present disclosure, the crack sensing tag comprises a dielectric substrate, a tag chip, an antenna, and a metal patch, the tag chip and the antenna being respectively attached to an upper surface of the dielectric substrate, wherein the tag chip being connected to the antenna, wherein the metal patch being attached to a lower surface of the dielectric substrate, and the antenna being connected to the metal patch.

According to another aspect of the present disclosure, the adjusting the structural parameter of the antenna of the crack sensing tag further includes: obtaining a frequency of the metal member to be tested corresponding to an intersection of an impedance curve of the antenna and an impedance curve of the tag chip under different crack depth conditions according to an impedance variation curve. When the crack depth is zero, the frequency corresponding to the intersection of the impedance curve of the antenna and the impedance curve of the tag chip is the first resonant frequency. Alternatively, when the crack depth is the upper limit of the crack, the frequency corresponding to the intersection of the impedance of the antenna and the impedance of the tag chip is the second resonant frequency. Further, the impedance variation curve is used to indicate a relationship between an impedance of the antenna, an impedance of the tag chip, and an actual operating frequency of the crack sensing tag.

According to another aspect of the present disclosure, the determining the actual opening frequency range of the crack sensing tag further includes for the depth of the crack being within the upper limit value a frequency corresponding to the peak of the power transmission coefficient of the crack sensing tag is a maximum value of the actual operating frequency, and for any frequency greater than the lower limit of the simulation frequency range and smaller than the maximum value of the actual operating frequency may be used as a minimum value of the actual operating frequency.

According to another aspect of the present disclosure, the crack sensing method further includes determining a geometry parameter of the antenna by using a suitable electromagnetic simulation software such as, but not limited to, a high frequency structural simulator (HFSS) and computer simulation technology (CST).

Finally, the method of the present disclosure is only a preferred embodiment and is not intended to limit the scope of the present disclosure. Any modifications, equivalent substitutions, improvements, and the like within the spirit and principles of the invention are intended to be included within the scope of the present disclosure.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A crack sensing tag comprising:
a dielectric substrate, a tag chip, an antenna, and a metal patch, the tag chip and the antenna being respectively attached to an upper surface of the dielectric substrate, wherein the tag chip being connected to the antenna, wherein the metal patch being attached to a lower surface of the dielectric substrate, and the antenna being connected to the metal patch.

2. The crack sensing tag of claim 1, wherein the dielectric substrate and the metal patch are respectively attached to a surface of a metal member to be tested, wherein the metal member to be tested being a flat metal member, further wherein a crack generated on the surface of the metal member to be tested being perpendicular to a long side of the crack sensing tag.

3. The crack sensing tag of claim 1 further comprising a shorting pin through which the antenna is connected with the metal patch.

4. The crack sensing tag of claim 1, wherein the tag chip is spaced apart from the antenna, and opposite pins of the tag chip are respectively connected to the antenna.

5. The crack sensing tag of claim 1, wherein the tag chip is configured to:
determine a simulation frequency range of the crack sensing tag according to an operating frequency range of a tag chip of the crack sensing tag;
determine a structural parameter of an antenna of the crack sensing tag such that a resonant frequency of the crack sensing tag does not exceed the simulation frequency range;
determine an actual operating frequency range of the crack sensing tag; and
monitor the crack according to a power transmission coefficient curve, wherein the actual operating frequency range does not exceed the simulation frequency range.

6. The crack sensing tag of claim 5, wherein the tag chip is further configured to determine a geometry parameter of the antenna by using an electromagnetic simulation software comprising at least one of a high frequency structural simulator (HFSS) or computer simulation technology (CST).

7. A crack sensing method comprising:
determining a simulation frequency range of a crack sensing tag according to an operating frequency range of a tag chip of the crack sensing tag;
determining a structural parameter of an antenna of the crack sensing tag such that a resonant frequency of the crack sensing tag does not exceed the simulation frequency range;
determining an actual operating frequency range of the crack sensing tag; and
monitoring the crack according to a power transmission coefficient curve, wherein the actual operating frequency range does not exceed the simulation frequency range.

8. The crack sensing method of claim 7, wherein the resonant frequency comprises a first resonant frequency and a second resonant frequency, wherein the first resonant frequency being a resonant frequency of the crack sensing tag when a crack depth is zero, further wherein the second resonant frequency being a resonant frequency of the crack sensing tag when the crack depth is an upper limit of the crack.

9. The crack sensing method of claim 7, wherein the determining the structural parameter of the antenna of the crack sensing tag further comprises adjusting the structural parameter of the antenna of the crack sensing tag by:
obtaining a frequency of the metal member to be tested corresponding to an intersection of an impedance curve of the antenna and an impedance curve of the tag chip under different crack depth conditions according to an impedance variation curve;
wherein when the crack depth is zero, the frequency corresponding to the intersection of the impedance curve of the antenna and the impedance curve of the tag chip is the first resonant frequency, wherein when the crack depth is the upper limit of the crack, the frequency corresponding to the intersection of the impedance of the antenna and the impedance of the tag chip is the second resonant frequency, further wherein the impedance variation curve is used to indicate a relationship between an impedance of the antenna, an impedance of the tag chip, and an actual operating frequency of the crack sensing tag.

10. The crack sensing method of claim 7, wherein the power transmission coefficient variation curve is used to indicate a relationship between a power transmission coefficient of the crack sensing tag, an impedance of the tag chip, and an impedance of the antenna.

11. The crack sensing method of claim 10, wherein the power transmission coefficient of the power transmission coefficient variation curve is calculated as:
$$τ = \frac{4 Re ( {Z}_{tag} ) Re ( {Z}_{chip} )}{\vert {Z}_{tag} + {Z}_{chip} \vert}$$
wherein τ is the power transmission coefficient of the crack sensing tag, Z_{tag} is the impedance of the antenna, Z_{chip} is the impedance of the tag chip; and Re (Z_{tag}) and Re (Z_{chip}) are the real parts of the impedance of the antenna and the tag chip, respectively.

12. The crack sensing method of claim 7, wherein the determining the actual opening frequency range of the crack sensing tag the determining an actual operating frequency range of the crack sensing tag comprises: for the depth of the crack within the upper limit value, a frequency corresponding to the peak of the power transmission coefficient of the crack sensing tag is a maximum value of the actual operating frequency, wherein any frequency greater than the lower limit of the simulation frequency range and smaller than the maximum value of the actual operating frequency may be used as a minimum value of the actual operating frequency.

13. The crack sensing method of claim 7 further comprising determining a geometry parameter of the antenna by using an electromagnetic simulation software comprising at least one of a high frequency structural simulator (HFSS) or computer simulation technology (CST).

14. A crack sensing method comprising:
determining, by a tag chip of a crack sensing tag, a simulation frequency range of the crack sensing tag according to an operating frequency range of a tag chip of the crack sensing tag;
determining, by the tag chip, a structural parameter of an antenna of the crack sensing tag by adjusting the structural parameter such that a resonant frequency of the crack sensing tag does not exceed the simulation frequency range, wherein the resonant frequency comprises a first resonant frequency and a second resonant frequency, the first resonant frequency being a resonant frequency of the crack sensing tag when a crack depth is zero, further wherein the second resonant frequency being a resonant frequency of the crack sensing tag when the crack depth is an upper limit of the crack;
determining, by the tag chip, an actual operating frequency range of the crack sensing tag; and
monitoring, by the tag chip, the crack according to a power transmission coefficient curve, wherein the actual operating frequency range does not exceed the simulation frequency range.

15. The crack sensing method of claim 14, wherein the crack sensing tag comprises a dielectric substrate, a tag chip, an antenna, and a metal patch, the tag chip and the antenna being respectively attached to an upper surface of the dielectric substrate, wherein the tag chip being connected to the antenna, wherein the metal patch being attached to a lower surface of the dielectric substrate, and the antenna being connected to the metal patch.

16. The crack sensing method of claim 15, wherein the adjusting the structural parameter of the antenna of the crack sensing tag further comprises:
obtaining a frequency of the metal member to be tested corresponding to an intersection of an impedance curve of the antenna and an impedance curve of the tag chip under different crack depth conditions according to an impedance variation curve;
wherein when the crack depth is zero, the frequency corresponding to the intersection of the impedance curve of the antenna and the impedance curve of the tag chip is the first resonant frequency, further wherein when the crack depth is the upper limit of the crack, the frequency corresponding to the intersection of the impedance of the antenna and the impedance of the tag chip is the second resonant frequency, wherein the impedance variation curve is used to indicate a relationship between an impedance of the antenna, an impedance of the tag chip, and an actual operating frequency of the crack sensing tag.

17. The crack sensing method of claim 15, wherein the power transmission coefficient variation curve is used to indicate a relationship between a power transmission coefficient of the crack sensing tag, an impedance of the tag chip, and an impedance of the antenna.

18. The crack sensing method of claim 17, wherein the power transmission coefficient of the power transmission coefficient variation curve is calculated as:
$$τ = \frac{4 Re ( {Z}_{tag} ) Re ( {Z}_{chip} )}{\vert {Z}_{tag} + {Z}_{chip} \vert}$$
wherein τ is the power transmission coefficient of the crack sensing tag, Z_{tag} is the impedance of the antenna, Z_{chip} is the impedance of the tag chip; Re (Z_{tag}) and Re (Z_{chip}) are the real parts of the impedance of the antenna and the tag chip, respectively.

19. The crack sensing method of claim 15, wherein the determining the actual opening frequency range of the crack sensing tag further includes for the depth of the crack being within the upper limit value a frequency corresponding to the peak of the power transmission coefficient of the crack sensing tag is a maximum value of the actual operating frequency, and for any frequency greater than the lower limit of the simulation frequency range and smaller than the maximum value of the actual operating frequency may be used as a minimum value of the actual operating frequency.

20. The crack sensing method of claim 15 further comprising determining a geometry parameter of the antenna by using an electromagnetic simulation software comprising at least one of a high frequency structural simulator (HFSS) or computer simulation technology (CST).
